(19) United States
(12) Patent Application Publication
(10) Pub. No.: US 2026/0286909 A1
(43) Pub. Date: Sep. 24, 2026

(54) VEHICLE START STOP CONTROL DURING VEHICLE REFUELING

(71) Applicant: Ford Global Technologies, LLC, Dearborn, MI (US)

(72) Inventors: Keith Weston, Canton, MI (US); Stuart C. Salter, White Lake, MI (US); Michael Mcnees, Flat Rock, MI (US); Brendan Diamond, Naples, FL (US); David S. Moyer, Sterling Heights, MI (US); Eric Michael Rademacher, Beverly Hills, MI (US); Ahmed Awadi, Farmington Hills, MI (US)

(21) Appl. No.: 19/087,217

(22) Filed: Mar. 21, 2025

(51) Int. Cl. F02D 41/04; B60H 1/00

(52) U.S. Cl. CPC F02D 41/042; B60H 1/00778

(57) ABSTRACT

Systems and methods for controlling automatic starting and stopping of a vehicle’s engine are described. In one example, output of a camera may be a basis for recognizing that a vehicle is about to be refilled with fuel. Vehicle adjustments may be performed to a vehicle based on recognizing that the vehicle is about to be refilled with fuel.

### FIELD

The present description relates to methods and a system for a vehicle start stop control system. The methods and system extend start stop control to fuel refilling sites.

### BACKGROUND

A vehicle may include start stop controls that allow the vehicle to automatically stop rotation of the vehicle’s engine to conserve fuel during periods when the vehicle is stopped. Vehicle start stop controls may monitor driver demand and vehicle slowing requests to decide whether or not to automatically stop and start the engine. These start stop controls are well suited to conserve fuel when the vehicle is stopped for a light or during period of heavy traffic. However, there may be other situations where the start stop system may not recognize that automatically stopping and restarting the engine may be appropriate and desirable. Therefore, it may be desirable to determine and evaluate situations heretofore that have not been considered as a basis for activating an automatic engine start and stop system.

The inventors herein have recognized the above-mentioned issues and have developed a method for a vehicle, comprising: via one or more controllers, recognizing a vehicle fuel refilling condition; and automatically stopping rotation of an engine of the vehicle in response to the vehicle being stopped and the vehicle fuel refilling condition being recognized.

By identifying a vehicle fuel refilling condition, it may be possible to automatically stop engine rotation to conserve fuel while controlling or maintaining a temperature within a vehicle’s passenger cabin. Automatically stopping the vehicle’s engine allows the vehicle to conserve fuel while passenger cabin temperature is controlled via an electric powered heating ventilation and air conditioning (HVAC) system. Consequently, passenger comfort may be maintained while a vehicle is being refueled.

The present description may provide several advantages. In particular, the approach may control passenger cabin temperature while a vehicle is being refueled. Further, for vehicles that do not include electric HVAC, the vehicle may prompt a user to take actions to maintain passenger cabin temperature. Additionally, the approach may be integrated with other vehicle start stop features and conditions to enhance vehicle start stop control.

The above advantages and other advantages, and features of the present description will be readily apparent from the following Detailed Description when taken alone or in connection with the accompanying drawings.

It may be understood that the summary above is provided to introduce in simplified form a selection of concepts that are further described in the detailed description. It is not meant to identify key features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic view of an example engine;

FIG. 2 is a schematic view of an example vehicle that includes the engine of FIG. 1;

FIG. 3 is a schematic view of an example hybrid vehicle that includes an internal combustion engine;

FIG. 4 illustrates a user preparing to refill a vehicle with fuel;

FIGS. 5 and 6 show a flowchart of a method for operating a vehicle that may automatically stop its internal combustion engine;

FIG. 6 shows an illustration of example vehicle display that may prompt a user to answer one or more questions related to operating a vehicle’s automatic start stop system; and

FIGS. 7A-7C show example user prompts.

### DETAILED DESCRIPTION

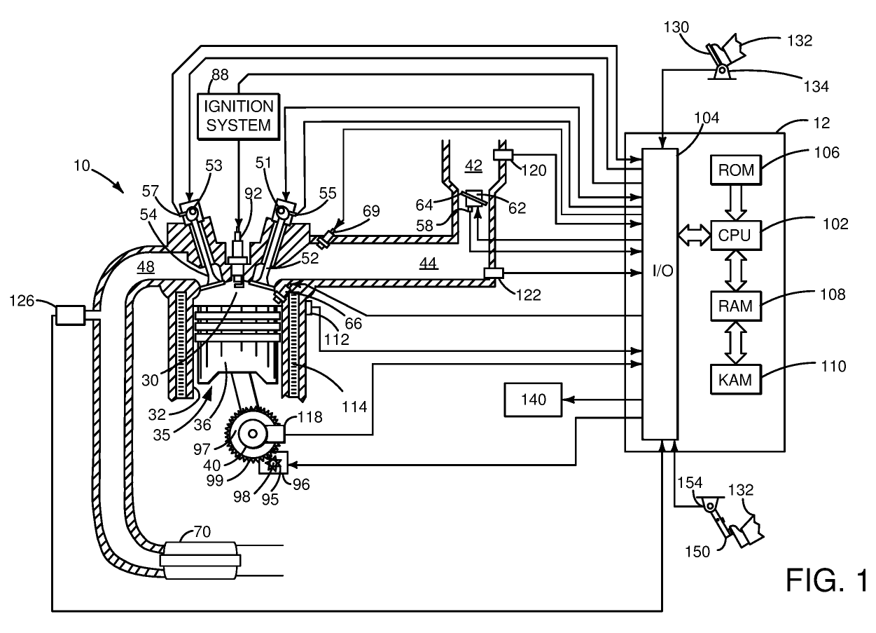

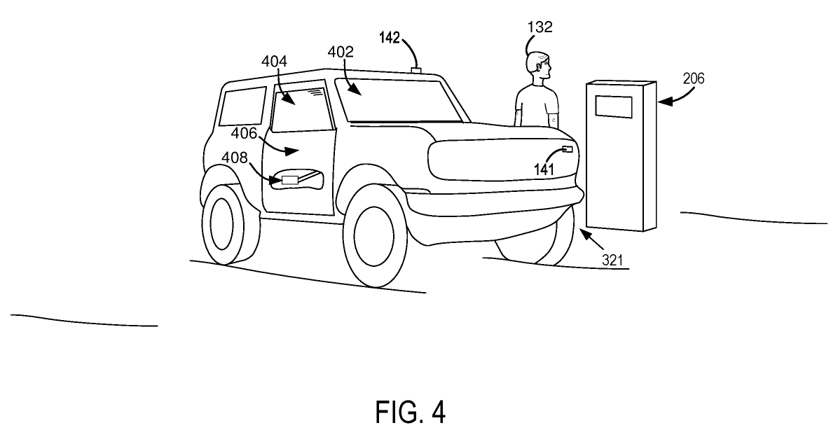

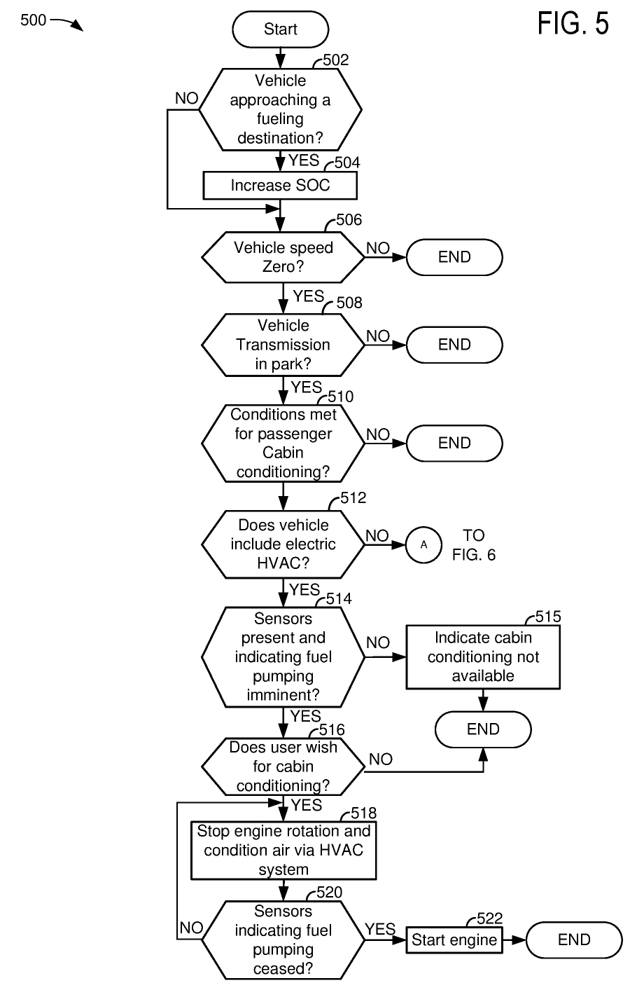

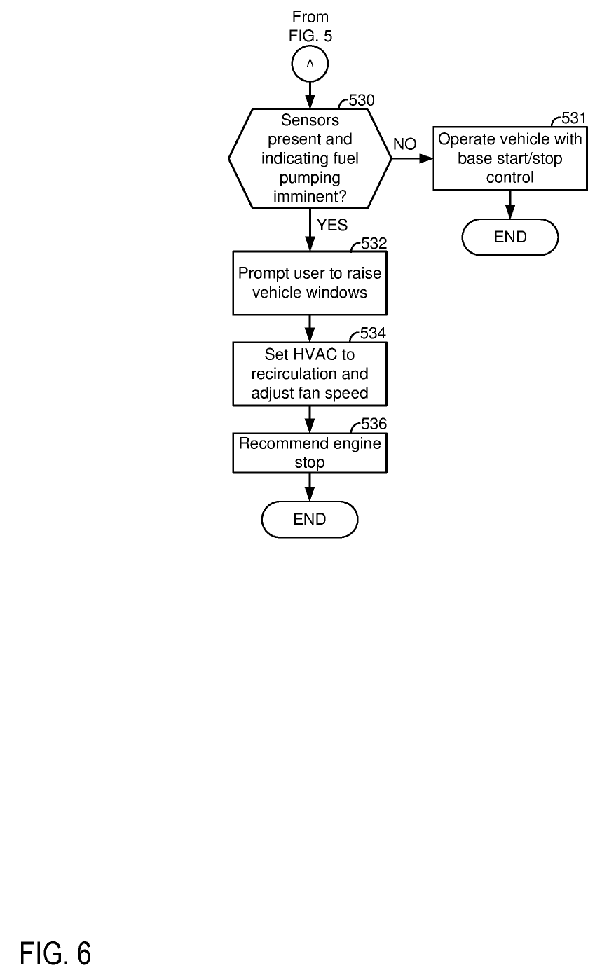

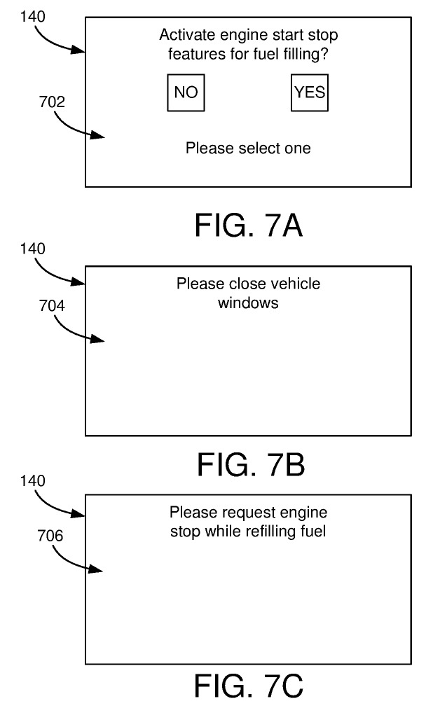

The present description is related to a method and system for a vehicle that automatically starts and stops the vehicle’s engine (e.g., a vehicle with a controller that decides to stop and start an internal combustion engine without a human making a request to stop and start the engine). The vehicle may be a hybrid vehicle or a non-hybrid vehicle. In one approach, one or more controllers receive data from a camera and decide whether or not the vehicle is about to be fueled based on the data from the camera. If the vehicle is about to be fueled, the method may stop the vehicle’s engine and continue to air condition the vehicle’s passenger cabin to maintain a comfort level of the vehicle. FIGS. 1-3 show example vehicle systems. FIG. 4 shows an example vehicle that is about to receive fuel. FIGS. 5 and 6 show flowcharts of a method for operating a vehicle. FIGS. 7A-7C show several example prompts that may be presented to a vehicle user.

Referring to FIG. 1, internal combustion engine 10 (also referred to as “engine”), comprising a plurality of cylinders, one cylinder of which is shown in FIG. 1, is controlled by electronic engine controller 12. Engine 10 includes combustion chamber 30 and cylinder walls 32 with piston 36 positioned therein and connected to crankshaft 40. Flywheel 97 and ring gear 99 are coupled to crankshaft 40. Starter 96 includes pinion shaft 98 and pinion gear 95. Pinion shaft 98 may selectively advance pinion gear 95 to engage ring gear 99. Starter 96 may be directly mounted to the front of the engine or the rear of the engine. In some examples, starter 96 may selectively supply torque to crankshaft 40 via an energy transfer device (e.g., a chain). In one example, starter 96 is in a base state when not engaged to the engine crankshaft. Combustion chamber 30 is shown communicating with intake manifold 44 and exhaust manifold 48 via respective intake valve 52 and exhaust valve 54. Each intake and exhaust poppet valve may be operated by an intake cam 51 and an exhaust cam 53. The position of intake cam 51 may be determined by intake cam sensor 55. The position of exhaust cam 53 may be determined by exhaust cam sensor 57.

Direct fuel injector 66 is shown positioned to inject fuel directly into cylinder 35, which is known to those skilled in the art as direct injection. Direct fuel injector 66 delivers liquid fuel in proportion to a voltage pulse width or fuel injector pulse width of a signal from controller 12. Fuel is delivered to fuel injector 66 by a fuel system (not shown) including a fuel tank, fuel pump, and fuel rail (not shown). Alternatively, or in addition, engine 10 may also include a port fuel injector 69 for each cylinder, which is known to those skilled in the art as port fuel injection. Port fuel injector 69 delivers liquid fuel in proportion to a voltage pulse width or fuel injector pulse width of a signal from controller 12. Fuel may be supplied to port fuel injector 69 via the fuel system (not shown).

Intake manifold 44 is shown communicating with optional electronic throttle 62 which adjusts a position of throttle plate 64 to control air flow from air intake 42 to intake manifold 44. In some examples, throttle 62 and throttle plate 64 may be positioned between intake valve 52 and intake manifold 44 such that throttle 62 is a port throttle.

Distributorless ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of catalytic converter 70. Alternatively, a two-state exhaust gas oxygen sensor may be substituted for UEGO sensor 126.

Converter 70 can include multiple catalyst bricks, in one example. In another example, multiple emission control devices, each with multiple bricks, can be used. Converter 70 can be a three-way type catalyst in one example.

Controller 12 is shown in FIG. 1 as a conventional microcomputer including: microprocessor unit 102, input/output ports 104, read-exclusive memory 106 (e.g., non-transitory memory), random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to a driver demand pedal 130 for sensing a distance displaced by human 132; a position sensor 154 coupled to caliper control pedal 150 for sensing distance displaced by human 132 (e.g., a vehicle user), a measurement of engine manifold pressure (MAP) from pressure sensor 122 coupled to intake manifold 44; an engine position sensor from a Hall effect sensor 118 sensing crankshaft 40 position; a measurement of air mass entering the engine from sensor 120; and a measurement of throttle position from sensor 58. Barometric pressure may also be sensed (sensor not shown) for processing by controller 12. In a preferred aspect of the present description, engine position sensor 118 produces a predetermined number of equally spaced pulses each revolution of the crankshaft from which engine speed (RPM) can be determined.

In some examples, the engine may be coupled to an electric motor/battery system in a hybrid vehicle. Further, controller 12 may receive input and communicate conditions such as degradation of components to illuminate a light, or alternatively, to infotainment system 140 (touch screen display and input device).

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC). During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion. During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

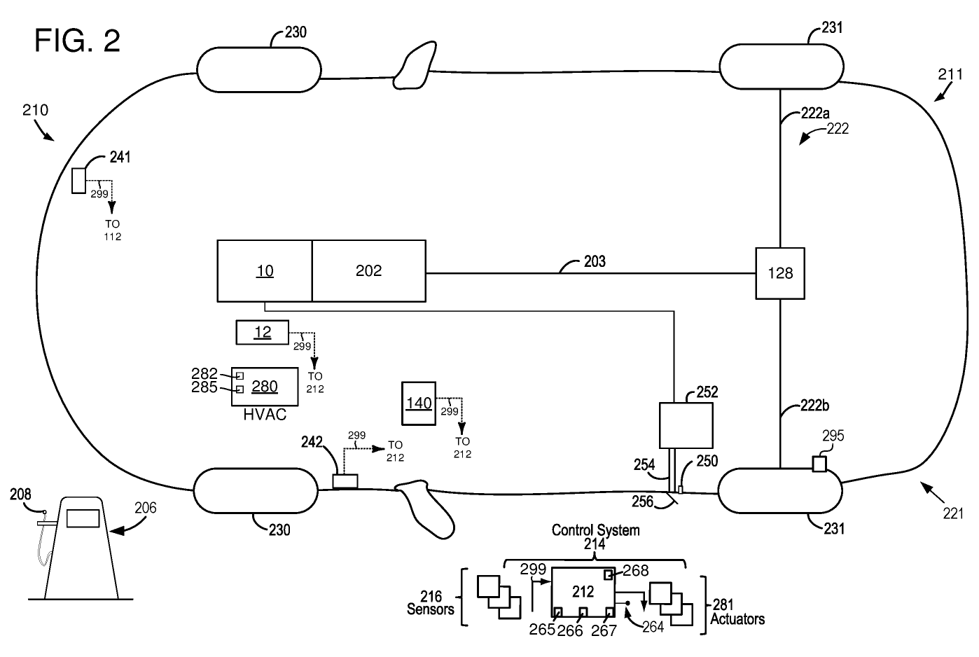

Referring now to FIG. 2, an example of a driveline 200 of a non-hybrid vehicle 221 is shown. Non-hybrid vehicle includes a front side 210 and a rear side 211. Non-hybrid vehicle 221 travels in a forward direction when front side 210 leads the way in vehicle movement. Non-hybrid vehicle 221 includes front wheels 230 and rear wheels 231.

Driveline 200 includes engine 10. Engine 10 delivers mechanical power to transmission 202 via crankshaft 40 (shown in FIG. 1). In the depicted example, transmission 202 is an automatic step ratio transmission. Transmission 202 is coupled to driveshaft 203 and it is coupled to axle 222. Axle 222 includes differential 228, first half shaft 222a, and second half shaft 222b. Differential 228 includes a differential gear set (not shown) that may deliver torque to first half shaft 222aand second half shaft 222b. Vehicle wheel speed may be indicated via one or more vehicle wheel speed sensors 295.

Infotainment system 140 (e.g., a human/machine interface) may receive input data from human 132 (as shown in FIG. 1) and may display messages and data to human 132. Infotainment system 140 may communicate to controller 12 via network 299 (e.g., a controller area network (CAN) or an Ethernet network) and vehicle control system 214 via network 299. Infotainment system 140 and/or vehicle controller 212 may also communicate with camera 242 and audible actuator 241 (e.g., a speaker or other sound exciter) via network 299. Although one camera is shown, it may be appreciated that a vehicle may include a plurality of cameras that provide different views of areas that surround non-hybrid vehicle 221. Camera 242 may provide images to infotainment system 140 where image recognition and image tracking confirmation of the fuel filler being placed in the vehicle and remaining there over fueling time may be determined. Cameras mounted on side view mirrors lend themselves nicely to being able to provide images for this determination. Further, other vehicle cameras may be configured on-the-fly to provide images that make refueling determination decisions.

Vehicle control system 214 includes a vehicle controller 212, non-transitory memory 265, random-access memory 266, digital/analog inputs and outputs 267, and a processing unit 268. Vehicle control system may issue commands to controller 12, infotainment system 240, and HVAC system 280. Further, vehicle control system may receive data from controller 12, infotainment system 240, and HVAC system 280. HVAC system 280 may provide heating or cooling to a vehicle passenger cabin (shown in FIG. 4). In one example, the HVAC system 280 may include a compressor that is mechanically driven via engine 10. The HVAC system 280 may include a fan 282 for circulating air in the vehicle’s passenger cabin. HVAC system 280 may be operated in a recirculation mode where air from the vehicle’s passenger cabin is recirculated to a heat exchanger 285 of the HVAC system 280 via fan 282.

Fuel may be supplied to non-hybrid vehicle 221 via fuel filler door 256. Fuel filler door 256 opens to provide access to fuel fill tube 254 and fuel tank 252. Fuel tank 252 supplies fuel to engine 10. Fuel filler door sensor 250 indicates whether fuel filler door 256 is open or closed to vehicle controller 212. Fuel tank 252 may receive fuel from fuel pump 206 when fuel fill nozzle 208 is inserted to fuel fill tube 254.

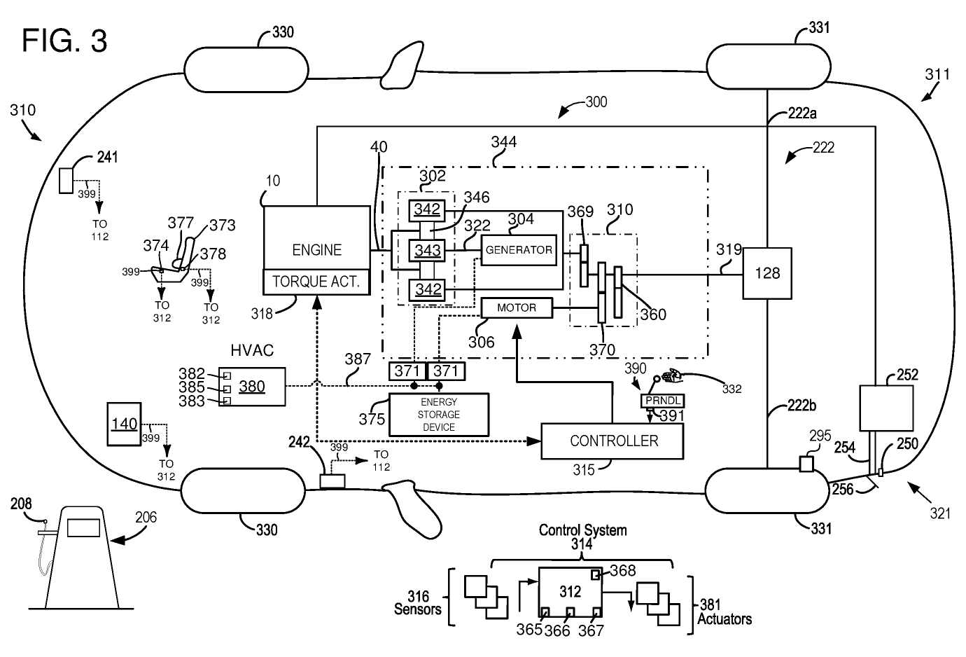

Referring now to FIG. 3, an example of a hybrid driveline 300 is shown. Driveline components that are the same as driveline components shown in FIGS. 1 and 2 are identified by the same numbers. For example, engine 10 of FIG. 1 is shown as engine 10 in FIG. 3. Therefore, for the sake of brevity, the description of these devices is omitted.

Driveline 300 includes engine 10 and torque actuator 318. Torque actuator 318 may be a throttle, fuel injector, camshaft actuator, ignition system, or other actuator that may adjust engine torque. Engine 10 delivers power to transmission 344 via crankshaft 40. In the depicted example, transmission 344 is a power-split transmission (or transaxle) that includes a planetary gear set 302 that includes one or more rotating gear elements. Transmission 344 further includes an electric generator 304 and an electric motor 306. The electric generator 304 and the electric motor 306 may also be referred to as electric machines as each may operate as either a motor or a generator. Torque may be output from transmission 344 to propel vehicle 321 using rear wheels 331 via a power transfer gearing 310, a torque output shaft 319, and an axle 222. Axle 222 includes differential 228, first half shaft 222a, and second half shaft 222b. Differential 228 includes a differential gear set (not shown) that may deliver torque to first half shaft 222aand second half shaft 222b. Controller 315 may control engine 10, electric generator 304, and electric motor 306. Alternatively, a separate controller may be provided for each of engine 10, electric generator 304, and electric motor 306.

Electric generator 304 and electric motor 306 are electrically coupled to electric energy storage device 375 such that each of electric generator 304 and electric motor 306 may be operated using electric energy from an electric energy storage device 375 (e.g., a high voltage battery). In some examples, an energy conversion device, such as an inverter 371, may be coupled between the electric energy storage device 375 and the motor to convert the DC output of the battery into an AC output for use by electric motor 306. Due to the mechanical properties of the planetary gear set 302, electric generator 304 may be driven by a power output element (on an output side) of the planetary gear set 302 via mechanical connection 322.

Electric motor 306 may be operated in a regenerative mode, that is, as a generator, to absorb kinetic energy from the vehicle and/or the engine and convert the absorbed kinetic energy to an energy form suitable for storage in electric energy storage device 375. In addition, electric motor 306 may be operated as a motor or generator, as assigned, to augment or absorb torque provided by the engine, such as during a transition of engine 10 between different combustion modes.

Planetary gear set 302 comprises a ring gear 342, a sun gear 343, and a planetary gear carrier 346. The ring gear and sun gear may be coupled to each other via the planetary gear carrier 346. Crankshaft 40 of engine 10 is mechanically coupled to planetary gear carrier 346 and sun gear 343 is mechanically coupled to electric generator 304. Ring gear 342 is mechanically coupled to power transfer gearing 310 including one or more meshing gear elements 360. Electric motor 306 drives gear element 370 and electric generator 304 is coupled to sun gear 343. In this way, the planetary gear carrier 346 (and consequently the engine and generator) may be coupled to the vehicle’s wheels and the electric motor 306 via one or more gear elements.

Hybrid propulsion system or driveline 300 may be operated in various modes including a full hybrid mode, wherein the vehicle is driven exclusively by engine 10 and electric generator 304 cooperatively, or exclusively by the electric motor 306, or a combination of the same. Alternatively, assist or mild hybrid examples may also be employed, wherein the engine 10 is the dominant source of power and the electric motor 306 selectively adds torque during specific conditions, such as during an drive pedal tip-in event (e.g., application of the driver demand pedal shown in FIG. 1).

The vehicle may be driven in a first engine-on mode, which may be referred to as an “engine” mode, wherein engine 10 is operated in conjunction with the electric generator 304 (which provides reaction torque to the planetary gear-set and allows a net planetary output torque for propulsion of the vehicle) and used as the dominant source of power and torque for powering rear wheels 331. In this mode, electric generator 304 may generate electric power, and the electric power generated may be applied by the electric motor 306 to propel the vehicle as well. This may result in no net power being delivered to the electric energy storage device 375 or the high voltage accessories from the engine power. If the electric motor 306 did not use the generator power, that generator power would have to be used by the high voltage accessories or to charge the high voltage battery. All power generated by the engine is consumed in a power split system. During the “engine” mode, fuel may be supplied to engine 10 from a fuel tank via direct fuel injector 66 (shown in FIG. 1) so that the engine can spin fueled to provide the torque for propelling the vehicle. Specifically, engine power is delivered to the ring gear 342 of the planetary gear set 302, thereby delivering power to rear wheels 331. Optionally, the engine may be operated to output more torque than is needed for propulsion, in which case the additional power may be absorbed by electric generator 304 (in a generating mode) to charge electric energy storage device 375 or supply electrical power for other vehicle electrical loads.

In another example, the hybrid propulsion system may be driven in a second engine-on mode, which may be referred to as an “assist” mode. During assist mode, engine 10 is operated and used as the dominant source of torque for powering rear wheels 331 and electric motor 306 is used as an additional torque source to act in cooperation with, and supplement the torque provided by engine 10. During the “assist” mode, as in the engine-exclusive mode, fuel is supplied to engine 10 so as to spin the engine fueled and provide torque to the vehicle wheels.

In still another example, the hybrid propulsion system or driveline 300 may be driven in an engine-off mode, which may be referred to as an electric-exclusive mode, wherein battery powered electric motor 306 is operated and used as the exclusive source of power for driving rear wheels 331. As such, during the engine-off mode, no fuel may be injected to engine 10 irrespective of whether the engine is spinning or not. The “engine-off” mode may be employed, for example, during vehicle slowing, during low driver demands, and while the vehicle is stopped at traffic signals, etc. Specifically, motor power is delivered to gear element 370, which in turn drives the meshing gear elements 360, thereby driving rear wheels 331. The electric generator 304 spins so that all of the rotation of ring gear 342 is balanced and planetary gear carrier 346 has a net zero speed, thereby allowing the engine to not spin.

During the engine-off mode, based on vehicle speed and driver demand torque, the vehicle may be operated in a first electric-exclusive mode, wherein the vehicle is propelled by the electric energy storage device 375 via the electric motor 306 with the engine not spinning and not fueled, or in a second electric-exclusive mode wherein the vehicle is propelled by the electric energy storage device 375 via electric motor 306 with the engine spinning unfueled. During the second electric-exclusive mode, the electric generator 304 applies torque to planetary gear set 302 through sun gear 343. The planetary gear carrier 346 provides reaction torque to this generator torque, and consequently directs torque to the engine 10 to spin the engine 10, during engine starting for example. In this example, the reaction torque provided by planetary gear carrier 346 is supplied to electric motor 306 (or alternatively vehicle momentum when vehicle speed is decreasing), and consequently reduces torque from the motor to the wheels. Vehicle wheel speed may be indicated via one or more vehicle wheel speed sensors 295.

Shifter 390 may receive input from human 132 (shown in FIG. 1) to select an operating mode for transmission 344. Shifter 390 may be placed into one of a plurality of positions or states as indicated by PRNDL. A driver may request that transmission 344 be in park when shifter 390 is moved to the “P” position. The driver may request that the transmission 344 be in reverse when shifter 390 is in the “R” position. The driver may request that the transmission 344 be in neutral when shifter 390 is in the “N” position. The driver may request that the transmission 344 be in drive when shifter 390 is in the “D” position. The driver may request that the transmission 344 be in low when shifter 390 is in the “L” position. Note that a low selection in the power split system is not a gear selection. Rather, it may simulate vehicle speed reduction via engine 10 when the drive demand pedal is fully released by generating more regenerative vehicle slowing torque and/or spinning the engine unfueled to generate a torque on the wheels to reduce vehicle speed. The position of shifter 390 may be determined via shifter position sensor 391.

Hybrid vehicle 321 also includes an infotainment system 140 (e.g., a human/machine interface) that may receive input data from human 132 (as shown in FIG. 1) and that may display messages and data to human 132. Infotainment system 140 may communicate to controller 312 via network 399 (e.g., a controller area network (CAN) or an Ethernet network) and vehicle control system 314 via network 399. Infotainment system 140 and/or vehicle controller 312 may also communicate with camera 242 and audible actuator 241 (e.g., a speaker or other sound exciter) via network 399. Although one camera is shown, it may be appreciated that a vehicle may include a plurality of cameras that provide different views of areas that surround non-hybrid vehicle 321. Infotainment system 140 may include a navigation system that shows the vehicle’s present location, destination, travel route, and other travel route waypoints and features. The navigation system may rely on satellites and/or a cellular network (not shown).

Vehicle control system 314 includes a vehicle controller 312, non-transitory memory 365, random-access memory 366, digital/analog inputs and outputs 367, and a processing unit 368. Vehicle control system may issue commands to controller 12, infotainment system 140, and HVAC system 380. Further, vehicle control system may receive data from controller 12, infotainment system 140, vehicle occupant sensor 374, and HVAC system 380. HVAC system 380 may provide heating or cooling to a vehicle passenger cabin (shown in FIG. 4). In one example, the HVAC system 380 may include a compressor 383 that is electrically driven via power supplied from high voltage bus 387 and electric energy storage device 375. The HVAC system 380 may include a fan 382 for circulating air in the vehicle’s passenger cabin. HVAC system 380 may be operated in a recirculation mode where air from the vehicle’s passenger cabin is recirculated to a heat exchanger 385 of the HVAC system 380 via fan 382. Vehicle occupant sensor 374 may be integrated into vehicle occupant holder 373 and a position of occupant element 377 may be determined via occupant sensor 378.

Referring now to FIG. 4, a perspective view of an example vehicle 321 with sensors and actuators for communicating instructions to a human 132 (user) is shown. In this view, audible actuator 141 is positioned on an exterior side of vehicle 321. This may allow human 132 to hear instructions and notifications that may be provided via controller 112 and/or other controllers. Further, camera 142 is shown on an exterior side of vehicle 321 so that it may have a view of vehicle fuel pump 206 that is external to vehicle 321.

Vehicle 321 includes a passenger cabin 402 that may hold passengers. Window 404 is shown in an open position where ambient air may flow into passenger cabin 402. Widow 404 is included in door 406, which is shown with a cut-away to reveal motor 408. In some examples, motor 408 may lift to close and lower to open window 404 in response to a request from human 132 or output of a controller (e.g., 312 of FIG. 3).

Thus, the system of FIGS. 1-4 provides for a vehicle system, comprising: a vehicle including one or more controllers including executable instructions stored in non-transitory memory that cause the one or more controllers to: identify an impending vehicle refueling and automatically stop rotation of the vehicle’s engine in response to the impending vehicle refueling. In a first example, the vehicle system further comprises a camera and additional executable instructions that cause the one or more controllers to recognize a presence or absence of a fuel pump via the camera. In a second example that may include the first example, the vehicle system further comprises additional executable instructions that cause the one or more controllers to recognize the fuel pump interfacing with the vehicle. In a third example that may include one or both of the first and second examples, the vehicle system includes where identification of the impending vehicle refueling is based on the camera detecting the fuel pump interfacing with the vehicle. In a fourth example that may include one or more of the first through third examples, the vehicle system includes where identification of the impending vehicle refueling is based on the vehicle arriving at a fuel refilling station. In a fifth example that may include one or more of the first through fourth examples, the vehicle system includes where identification of the impending vehicle refueling is based on a position of a fuel filler door. In a sixth example that may include one or more of the first through fifth examples, the vehicle system includes where identification of the impending vehicle refueling is based on a vehicle user being off of a vehicle occupant holder. In a seventh example that may include one or more of the first through sixth examples, the vehicle system further comprises additional executable instructions that cause the one or more controllers to control a temperature of a passenger cabin of the vehicle.

Turning now to FIGS. 5 and 6, a flowchart of a method 500 for automatically starting and stopping rotation of an internal combustion engine. The method of FIGS. 5 and 6 may be stored as executable instructions in non-transitory memory of one or more controllers. The method of FIGS. 5 and 6 may be incorporated into the system of FIGS. 1-4. A controller may change operating states of one or more devices in the real world according to the method of FIGS. 5 and 6. The method of FIGS. 5 and 6 may provide prompts as shown in FIGS. 7A-7C.

At 502, method 500 judges whether or not the vehicle is approaching a fueling destination (e.g., a fuel filling station) and within a predetermined distance of the fueling destination. Thus, method 500 may judge if the vehicle arrives at a fuel filling station. The fueling destination may be a destination that is input to or set by the vehicle’s navigation system. The fueling destination may be selected via the vehicle’s user (e.g., human 132) or automatically by the vehicle itself. If method 500 judges that the vehicle is approaching a fueling destination and is within a predetermined distance of the fueling destination, the answer is yes and method 500 proceeds to 504. Otherwise, the answer is no and method 500 proceeds to 506.

At 504, method 500 may increase a state of charge (SOC) of the vehicle’s electric energy storage device (e.g., a traction battery that supplies electric power to an electric machine that propels the vehicle). In one example, method 500 may attempt to increase SOC of the electric energy storage device to a predetermined level (e.g., between 70% and 90% of maximum SOC for the electric machine). Method 500 may increase engine output and charge the electric machine using power from the internal combustion engine. Additionally, in some examples, method 500 may not increase the electric machine SOC, except if the vehicle user has requested passenger cabin air conditioning during fuel refilling. Method 500 proceeds to 506.

At 506, method 500 judges whether or not the vehicle speed is zero. If not, the answer is no and method 500 proceeds to exit. If so, the answer is yes and method 500 proceeds to 508. Additionally, in some examples, method 500 may specify that the vehicle be proximate (e.g., within a predetermined distance (two meters)) to a fuel pump to proceed to 508.

At 508, method 500 judges whether or not the vehicle’s transmission is engaged in park. If so, the answer is yes and method 500 proceeds to 510. Otherwise, the answer is no and method 500 proceeds to exit.

At 510, method 500 judges whether or not conditions have been met for passenger cabin air conditioning. If so, the answer is yes and method 500 proceeds to 512. Otherwise, the answer is no and method 500 proceeds to exit. In one example, the conditions for passenger cabin air conditioning to occur may include one or more of a user not being present in a driver’s position, a fuel pump being within a predetermined distance of the vehicle, driver element being unfastened, fuel filler door being open, fuel pump inserted into a fuel filler neck, vehicle user interfacing with a fuel pump, and the user requesting passenger cabin air conditioning during fuel refilling as a default or after being prompted to engage passenger cabin air conditioning during fuel refilling while the vehicle’s engine is not rotating and combusting fuel. Additionally, in some examples, method 500 may proceed to 512 solely if the vehicle is in an “on” or operational state. Method 500 proceeds to 512.

Machine learning or an artificial intelligence assistant may associate drivers with their practices at fuel stations to optimize automatic engine start stop timing so that the system may be configured to shut off the engine exclusively when the fuel nozzle is removed from the fuel pump. For example, for a user that go into a store to pre-pay or buy items before fuel filling, the system can be configured to stop engine rotation as soon as the vehicle is in front of a fuel pump and put into PARK.

At 512, method 500 judges whether or not the vehicle’s HVAC system includes an electrically powered compressor. If so, the answer is yes and method 500 proceeds to 514. Otherwise, the answer is no and method 500 proceeds to 530.

At 530, method 500 judges whether or not the vehicle includes sensors to determine or predict whether or not refilling conditions of the vehicle with fuel will occur in a short time (e.g., less than 5-10 seconds) are present, and whether or not based on data provided by these sensors, an indication is provided that fuel pumping to the vehicle is expected within a predetermined period (e.g., in the next 10 seconds). If so, the answer is yes and method 500 proceeds to 532. Otherwise, the answer is no and method 500 proceeds to 531.

At 531, method 500 operates the vehicle with its base automatic start stop control. The base automatic start stop control may automatically stop engine rotation when vehicle speed is zero, the vehicle caliper control pedal is applied, driver demand is less than a threshold, and traction battery state of charge (SOC) is greater than a threshold SOC. Method 500 proceeds to exit.

At 532, method 500 prompts the user to raise the vehicle’s windows and to manually stop the vehicle’s engine. Raising the vehicle’s windows may make it more difficult for conditioned air in the vehicle to escape to ambient air. By raising the vehicle’s windows, it may be possible to extend the amount of time that the vehicle’s passenger cabin remains near a desired temperature when the vehicle is being refueled. These actions may increase comfort of vehicle occupants and of the user that is filling the vehicle with fuel when the user reenters the vehicle. In some examples, a vehicle controller may automatically close vehicle windows. Method 500 proceeds to 534.

At 534, method 500 adjusts the HVAC system to a recirculation mode where air within the passenger cabin is recirculated through the HVAC system. Further, method 500 may increase a fan speed of the HVAC system. By increasing the fan speed of the HVAC system, it may be possible to extend the amount of time that the vehicle’s passenger cabin remains near a desired temperature when the vehicle is being refueled. These actions may increase comfort of vehicle occupants and of the user that is filling the vehicle with fuel when the user reenters the vehicle. Method 500 proceeds to 536.

At 536, method 500 recommends the user to request that the vehicle’s engine be stopped. This recommendation may be based on some geographical areas where engine stopping is specified at vehicle fuel refilling stations. If the user does not request an engine stop, the engine continues to rotate and combust fuel. Method 500 proceeds to exit.

At 514, method 500 judges whether or not the vehicle includes sensors to determine or predict whether or not refilling of the vehicle with fuel in a threshold period of time (e.g., 5-10 seconds) is present, and whether or not based on data provided by these sensors, an indication is provided that fuel pumping to the vehicle is imminent and/or expected within a predetermined period (e.g., in the next 10 seconds). If so, the answer is yes and method 500 proceeds to 516. Otherwise, the answer is no and method 500 proceeds to 515.

The sensors that may be a basis for recognizing that the vehicle is about to be refilled with fuel may include but are not limited to the fuel filler door sensor indicating an open fuel door condition, the camera and image processing software detecting the vehicle being near a fuel pump, the camera and image processing software detecting the fuel pump hose being installed in a fuel filler neck, the vehicle shifter position and user location sensing (e.g., occupant fastened sensor, occupant sensor, etc.), etc.

At 515, method 500 indicates that passenger cabin air conditioning is not available via the vehicle’s human/machine interface. Method 500 proceeds to exit.

At 516, method 500 judges whether or not the vehicle’s user (e.g., a human) wishes for or requests passenger cabin air conditioning, such as heating or cooling. In one example, the vehicle may query the vehicle user for the information. In other examples, the vehicle may make a base assumption of passenger cabin air conditioning being requested without an actual request by the vehicle’s user. The vehicle’s user may overcome this assumption. If method 500 judges that the vehicle’s user wishes for or requests passenger cabin air conditioning, the answer is yes and method 500 proceeds to 518. Otherwise, the answer is no and method 500 proceeds to exit such that the vehicle’s base automatic engine starting and stopping procedure may control automatic engine starting and stopping.

At 518, method 500 automatically stops rotation of the vehicle’s engine. Automatically stopping rotation of the engine may include ceasing spark supplied to the engine and/or ceasing fuel flow to the engine. Method 500 also controls air temperature within the passenger cabin of the vehicle via the HVAC system. The HVAC system may include an electrically driven compressor and fan that operate to cool or heat the passenger cabin. Method 500 may control the temperature within the vehicle’s passenger cabin to a predetermined temperature. Method 500 proceeds to 520.

At 520, method 500 judges whether or not the vehicle’s sensors indicate conditions that fuel pumping has ceased. If so, the answer is yes and method 500 proceeds to 522. Otherwise, the answer is no and method 500 returns to 518.

At 520, method 500 automatically restarts the internal combustion engine. Method 500 may restart the engine via rotating the engine with a starter or the motor. Method 500 also begins injecting fuel to the engine. Method 500 may also deliver spark to the engine. The engine is restarted without an engine restart request from the vehicle’s user. Method 500 proceeds to exit.

Thus, method 500 provides for a method for a vehicle, comprising: via one or more controllers, recognizing a vehicle fuel refilling condition; and automatically stopping rotation of an engine of the vehicle in response to the vehicle being stopped and the vehicle fuel refilling condition being recognized. In a first example, the method includes where the vehicle fuel refilling condition is recognized via a camera. In a second example that may include the first example, the method includes where the vehicle fuel refilling condition the vehicle being proximate to a vehicle fuel pump, where the vehicle fuel pump is external to the vehicle. In a third example that may include one or both of the first and second examples, the method further comprises controlling a vehicle passenger cabin temperature via an electric powered heating, ventilation, and air conditioning system while the engine has stopped rotating. In a fourth example that may include one or more of the first through third examples, the method further comprises increasing a state of charge of a battery in response to a request to navigate to a fuel refilling station. In a fifth example that may include one or more of the first through fourth examples, the method includes where the vehicle fuel refilling condition is recognized via a position of a fuel filler door. In a sixth example that may include one or more of the first through fifth examples, the method includes where the vehicle fuel refilling condition is recognized via a passenger buckling being released.

Method 500 also provides for a method for a vehicle, comprising: via one or more controllers, recognizing a vehicle fuel refilling condition; and automatically performing adjustments to operation of the vehicle in response to the vehicle fuel refilling condition being recognized. In a first example, the method includes where the adjustments include prompting a user to close one or more vehicle windows. In a second example that may include the first example, the method includes where the adjustments include increasing a fan speed and placing an air conditioning system in a recirculation mode. In a third example that may include one or both of the first and second examples, the method further comprises prompting a user to request an engine stop in response to the vehicle fuel refilling condition being recognized. In a fourth example that may include one or more of the first through third examples, the method includes where recognizing the vehicle fuel refilling condition is based on output of a camera.

Referring now to FIGS. 7A-7C, examples of prompts requesting user action are shown. In particular, FIG. 7A shows an example prompt that may be presented to a user via HMI 140. The prompt of FIG. 7A requests that the user choose whether or not to activate engine start stop control and passenger cabin air conditioning during fuel refilling. The user may select their choice via the HMI. FIG. 7B shows an example prompt to request that the user closes vehicle windows at the onset of fuel refilling so that cabin temperature may be maintained closer to a target value. FIG. 7C shows an example prompt to request that the user request an engine stop during fuel refilling. The HMI described herein may provide these prompts and others to the vehicle’s user. The prompts may be provided to the user while the user is inside or outside of the vehicle. In some examples, the user may be prompted via an audible request.

Note that the example control and estimation routines included herein can be used with various vehicle system configurations. The control methods and routines disclosed herein may be stored as executable instructions in non-transitory memory and may be carried out by the control system including one or more controllers in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing may be different than is illustrated here to achieve the features and advantages of the example embodiments described herein, but the illustrations herein are provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, electric and hybrid vehicle configurations could use the present description to advantage.

1. A method for a vehicle, comprising:
via one or more controllers, recognizing a vehicle fuel refilling condition; and
automatically stopping rotation of an engine of the vehicle in response to the vehicle being stopped and the vehicle fuel refilling condition being recognized.

2. The method of claim 1, where the vehicle fuel refilling condition is recognized via a camera.

3. The method of claim 2, where the vehicle fuel refilling condition is the vehicle being proximate to a vehicle fuel pump, where the vehicle fuel pump is external to the vehicle.

4. The method of claim 1, further comprising controlling a vehicle passenger cabin temperature via an electric powered heating, ventilation, and air conditioning system while the engine has stopped rotating.

5. The method of claim 1, further comprising increasing a state of charge of a battery in response to a request to navigate to a fuel refilling station.

6. The method of claim 1, where the vehicle fuel refilling condition is recognized via a position of a fuel filler door.

7. The method of claim 1, where the vehicle fuel refilling condition is recognized via an occupant exiting.

8. A vehicle system, comprising:
a vehicle including one or more controllers including executable instructions stored in non-transitory memory that cause the one or more controllers to: identify an impending vehicle refueling and automatically stop rotation of an engine of the vehicle in response to the impending vehicle refueling.

9. The vehicle system of claim 8, further comprising a camera and additional executable instructions that cause the one or more controllers to recognize a presence or absence of a fuel pump via the camera.

10. The vehicle system of claim 9, further comprising additional executable instructions that cause the one or more controllers to recognize the fuel pump interfacing with the vehicle.

11. The vehicle system of claim 10, where identification of the impending vehicle refueling is based on the camera detecting the fuel pump interfacing with the vehicle.

12. The vehicle system of claim 8, where identification of the impending vehicle refueling is based on the vehicle arriving at a fuel refilling station.

13. The vehicle system of claim 8, where identification of the impending vehicle refueling is based on a position of a fuel filler door.

14. The vehicle system of claim 8, where identification of the impending vehicle refueling is based on a vehicle occupant sensing.

15. The vehicle system of claim 8, further comprising additional executable instructions that cause the one or more controllers to control a temperature of a passenger cabin of the vehicle.

16. A method for a vehicle, comprising:
via one or more controllers, recognizing a vehicle fuel refilling condition; and
automatically performing adjustments to operation of the vehicle in response to the vehicle fuel refilling condition being recognized.

17. The method of claim 16, where the adjustments include prompting a user to close one or more vehicle windows.

18. The method of claim 16, where the adjustments include increasing a fan speed and placing an air conditioning system in a recirculation mode.

19. The method of claim 16, further comprising prompting a user to request an engine stop in response to the vehicle fuel refilling condition being recognized.

20. The method of claim 16, where recognizing the vehicle fuel refilling condition is based on output of a camera.
